(19) United States
(12) Patent Application Publication
(10) Pub. No.: US 2002/0022045 A1
(43) Pub. Date: Feb. 21, 2002

(54) SHARK DETERRENT

(76) Inventor: DAVID P. SCHNEIDER, APALACHIN, NY (US)

Correspondence Address: DAVID P SCHNEIDER, 4 WOODSIDE DR EAST, APALACHIN, NY, 13732

(21) Appl. No.: 09/375,767

(22) Filed: Aug. 17, 1999

(51) Int. Cl. A01N 25/00; A01N 25/08; A01N 43/02; A01N 37/00

(52) U.S. Cl. 424/409; 514/558; 514/449

(57) ABSTRACT

To provide a chemical conglomerate which when properly coated or contained can dissolve over very long periods of time in sea water that will discourage shark attack or attacks by other sea creatures that are sensitive to the included chemicals. This chemical can be carried into the sea in many different designs of packaging so that eventually, when called upon, it will dissolve into the sea water and be there in enough quantity to deter sharks that would otherwise attack and cause damage.

### REFERENCES CITED

U.S. Pat. No. 4,602,384 July, 1986 Schneider 2/2

U.S. Pat. No. 4,917,280 April, 1990 Schneider 224/223

U.S. Pat. No. 4,933,187 June, 1990 Schneider 424/497

### FIELD OF THE INVENTION

The present invention pertains to chemically protecting against sharks or other dangerous sea creatures that are sensitive to these chemical deterrents.

### BACKGROUND OF THE INVENTION

To date, my patented means of deterring shark attack is to utilize the arts taught in my existing patents. These patents are U.S. Pat. Nos. 4,602,384 and 4,917,280 and 4,933,187. They describe my coated chemical pellets and the various protective coatings utilized to prolong or prevent the melting of those chemical pellets. It can be noted in reviewing these patents that almost all of the protective coatings described melt in water so they will subsequently dissolve and expose the chemicals they cover. These shark repulsive chemicals will then also melt in the water since their protective coatings have been melted away. Some of the coatings are insoluble, they must be broken open physically before the chemicals will be exposed to the water in which they are immersed when in use.

### SUMMARY OF THE INVENTION

It is an object of the present invention to produce a shark repulsive chemical cylinder or other shaped chemical conglomerate, even particulates, the ingredients of which, such as Sodium Lauryl Sulfate and Sodium Sulfate, are described in my previous patents listed above. The water proof coating on this cylinder or other shaped chemical conglomerates will act in a somewhat different fashion then those described in my previously mentioned patents.

It is another object of this invention to eliminate the need for certain manufacturing steps presently necessary in production of these coated chemical conglomerate shapes.

It is a further object of this invention to use bulkheads or special chemical conglomerate shapes which by their very configuration help prolong the dissolution time taken to completely dissolve the chemical out of its containment.

It is still a further object of this invention to provide a container for these chemical conglomerates which may be a separate part from the chemical conglomerate yet protect it from too fast a dissolving rate.

It is a further object of this invention to provide a plastic or metallic container for the chemicals which will negate the need for water proof or water retardant coatings.

It is yet another object of this invention to describe a different and more effective mixture of chemicals for deterring shark attacks.

### BRIEF DESCRIPTION OF THE DRAWINGS

FIG. 1 is a side view of a chemical cylinder coated with the containment materials which are one embodiment of the invention's systems;

FIG. 2 is a side view of a chemical cylinder showing one method for improved manufacturing tooling techniques;

FIG. 3 is a side view of a group of chemical conglomerate cylinders showing another possible arrangement of these cylinders in relationship to one another;

FIG. 4 is a side view of a chemical conglomerate shaped to prolong melting;

FIG. 5 is a side view of a chemical conglomerate placed inside a rigid or flexible container without the use of any surface coatings.

### DESCRIPTION OF THE PREFERRED EMBODIMENTS

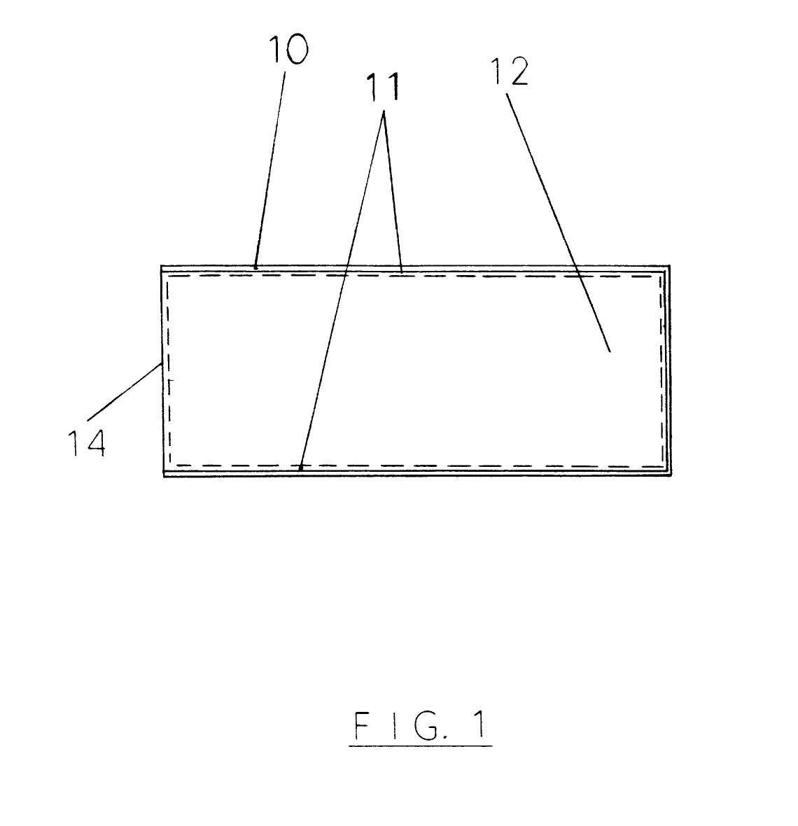

Referring now to the drawings wherein like reference characters indicate like parts in the several views, there is shown in FIG. 1 a chemical conglomerate 12 in the shape of a cylinder. This cylinder 12 is the basic type of shape but not the exclusive shape for this chemical conglomerate so many other shapes could be utilized. In one embodiment of this chemical conglomerate it is made of a dry, granular anhydrous sodium sulfate and liquid sodium lauryl sulfate mixed together in a ratio by volume which is at least two thirds liquid sodium lauryl sulfate to no more than one third dry, granular anhydrous sodium sulfate. To this mixture can be added varying amounts of polyvinyl acetate resin latex (commonly known as organic, water soluble, white liquid glue) which adds the effect of prolonging the time for a given volume of the mixture to dissolve into water when the chemical conglomerate which contains this white glue is immersed into water. The sodium sulfate acts as a drying agent for the sodium lauryl sulfate. After drying the chemical conglomerate can be made into any shape, even particulates. The white glue acts as a water soluble binder. This chemical conglomerate in a cylinder shape 12 may also have, if desired to retard its melting in water, one or more coatings of slower melting materials of different kinds suitable for that purpose. One such material is common liquid white glue but there are numerous other types of materials which could perform the same function. This coating 11 would be applied as a first completely encompassing coating to slow the melting of the chemical conglomerate in the cylinder shape. This first coating 11 could then have over top of it applied a waterproof coating 10. This waterproof coating 10 is applied to all but one end 14 of the chemical conglomerate. It could be further restricted in its application to just one narrow strip on that end 14 or on the side of the chemical conglomerate cylinder shape 12 or to an even smaller area such as an area of only a half inch in diameter or even smaller if desired. The first coating 11 can be made for example of white glue or some other slow melting material by dipping the dried chemical conglomerate shape into a vat of this liquified slow melt coating. The dipping, if desired, could stop short of totally immersing the shape 12 so that its one end 14, for example, would not be coated with the coating agent 11. In some cases, it would be proper, depending on the intended use for the finished chemical part, to totally immerse the chemical conglomerate cylinder 12 into the liquid so it would be totally coated. Another means of applying a coating such as coating 11 onto the chemical conglomerate cylinder 12 would be to spray it on or roll or brush it onto the chemical's surface. All these application methods, as well as other applicable methods not mentioned, are well known coating techniques in industry and could be utilized for this coating purpose. The second coating 10 may be applied in the same way as coating 11 or it may be injected around the chemical conglomerate cylinder as it rests inside a mold if the waterproof coating 10 is viscous enough to merit this method of application. Of course, the chemical conglomerate cylinder itself 12 could be made in a mold but could also be formed by utilizing any other commonly practiced techniques for forming such shapes out of particulates such as compacting under great force inside a set of dies. The overall purpose for not coating the one end 14 of the chemical conglomerate cylinder 12 or some other small portion of its surface with the waterproof coating 10 is so that when it is immersed, the water in which it is immersed will have access only through that opening in the coating 10 to get into the interior of the coated chemical conglomerate cylinder 12. In this way, the water can dissolve the contained chemical inside the chemical conglomerate cylinder without the need for the user to break open the waterproof coating before any melting can occur. This one small opening where the waterproof coating has not been put in place allows for a very small, restricted flow of water to penetrate into the inside of the chemical conglomerate cylinder where the chemical is located. This has the effect, when compared to a chemical conglomerate cylinder that has no type 10 waterproof coating, of slowing the melting of the chemical contained inside the chemical conglomerate cylinder. This is so that the chemical dissolution into the water takes place over a longer period of time as compared to a chemical conglomerate cylinder which has only a slow melting coating 11 in place. Of course the description of this chemical as being cast and shaped in the form of a cylinder is not intended to indicate that other shapes for the chemical conglomerate are not allowed or covered by this patent. Any shape desired for the chemical conglomerate can be used including the cylindrical form and still be covered by this patent. It is also logical that either one or both of the coatings 11 and 10 could be replaced by what is commonly called a tin can or aluminum can. This also would produce the desired waterproof containment of the chemical conglomerate and have the same effect of slowing down the rate at which the contained chemical conglomerate melted. Such a can could be exactly like current day soda pop cans with a flip or pop top opening that could be opened by the user at the time of use. This metal can approach would provide the very size opening in the one end of the waterproof containment that this embodiment in FIG. 1 describes. Of course, the application which requires the chemical conglomerate to be exposed to the water without any human intervention would require a top on the can which had a hole in place that had no closure. Then, in an emergency such as a ship sinking, the can containing the chemical conglomerate, which could be attached to the user's person or life raft, could automatically start melting through such a hole in the can's top as soon as it was immersed into the water.

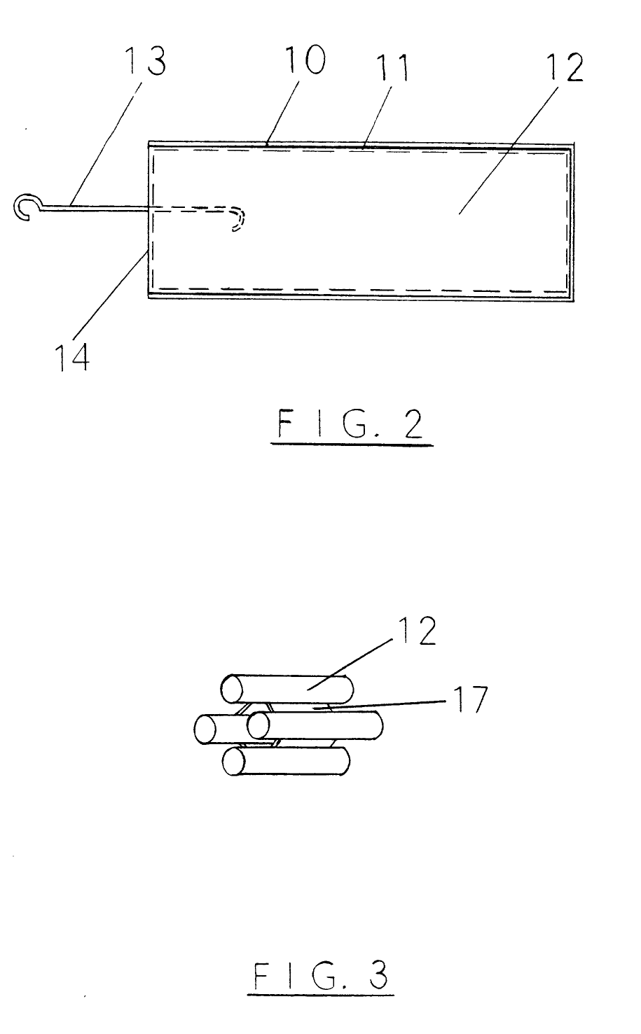

FIG. 2 shows the same chemical cylinder as in FIG. 1 but with a piece of twine or string or wire 13 cast inside the chemical conglomerate cylinder when the cylinder was formed. Such a wire or string tool 13 may be used to hang the cylinder suspended in air without the need to touch the cylinder. This will allow the cylinder to be immersed into a vat of liquified coating material much more readily than if such a tool was not included in the cylinder's structure. It will also facilitate the subsequent drying of the coated cylinder by providing for it to be hung in mid air untouched by any supporting means which would be needed if this wire or string tool 13 was not in place on the cylinder. If desired, this tool can be cut away after all manufacturing is completed.

FIG. 3 shows the same chemical cylinder 12 as in FIG. 1 but situated in a pattern in proximity with other chemical cylinders. These other chemical cylinders may be the same as all their neighboring cylinders or they may each contain different chemicals or even contain mechanical or electrical or electronic devices intended for the revulsion of sharks or other sea creatures. These cylinders or other shapes can be held in permanent positions in reference to one another by the same material used to form coating 10 as identified in FIG. 1 or they may be situated near one another and held in that situation by some other mechanical means such as a metal or plastic framework 17. The arrangement of these shapes in relationship to one another may describe any pattern and not just the circular one shown.

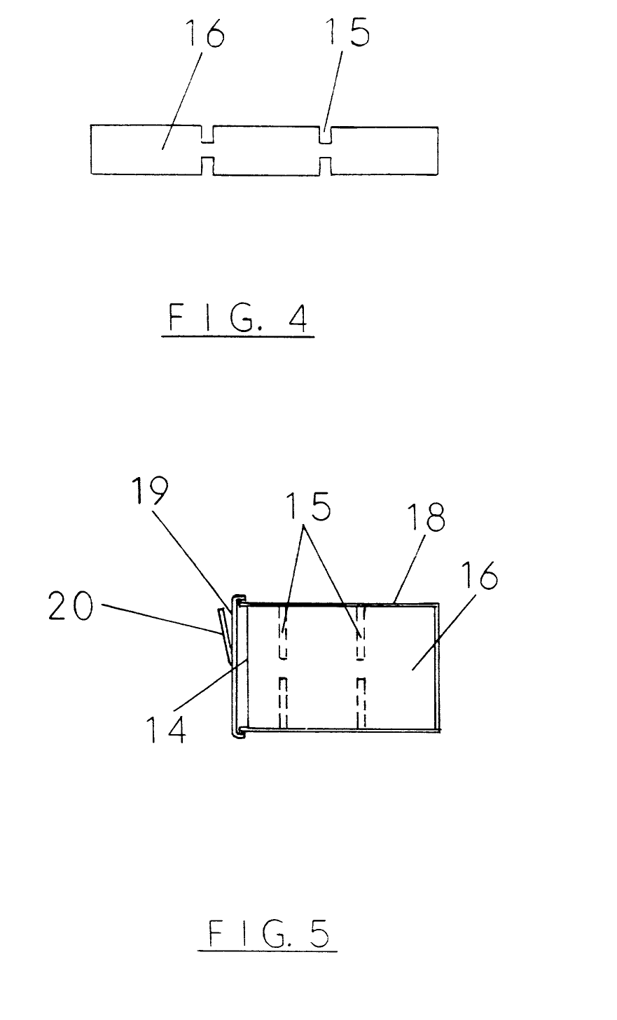

FIG. 4 shows the same chemical cylinder 12 as in FIG. 1 but somewhat elongated in shape and displaying a narrow section (which item 15 can also be described as a bulkhead created restriction) 15 at regular intervals which is smaller in diameter that those larger diameter sections 16 on either side of it. This restriction 15 is useful in diminishing the amount of water that can wash in upon the chemical located in each of the adjoining large diameter segments 16. This can slow the sequential melting of the chemicals in each of the successive large diameter chambers 16 and have the effect of making the whole chemical assembly slower melting in the water. This restriction 15 can be effected by molding it into the molded shape of the chemical conglomerate before that completed shape is coated. This restricted orifice can also be accomplished by creating a plastic disc with a hole in its center or a multiple number of small holes in its center section. By placing duplicates of this plastic disc into the chemical conglomerate's molded shape or into its aluminum can during the formation of the chemical conglomerate inside that can this plastic disc will form repeatedly spaced bulkheads 15 into the mold at regular intervals. These bulkheads can then become an integral part of the completed chemical cylinder 12. Such a bulkhead part could be made of any rigid or semirigid or flexible material and have a small hole piercing its center or have several holes piercing it in several locations so the water could get through each bulkhead and into the next chamber beyond this bulkhead without entering that next chamber in too large a volume of flow. This will have the effect of slowing the melting rate of any chemical conglomerate so equipped with these bulkheads formed out of the above described discs.

FIG. 5 shows the same chemical cylinder 12 as in FIG. 1 but it is inserted into or even originally formed inside a rigid or semi rigid or flexible container 18. This container 18 can be filled or packed with the chemical conglomerate mixture 12 and, if desired, then sealed shut with a top 19 much the same as in the manufacture of many other products which are sold in sealed cans or plastic containers. These currently commercially available container systems have, in the general case of aluminum beverage containers, a flip top closure tab 20 which can be readily snapped open by the user. Placing the chemical conglomerate inside a metal or plastic container has the effect of making the wall of the can or container which contains the chemical conglomerate substitute for and function as the waterproof coating or covering 10 as described in FIG. 1. This waterproof coating 10 could however be utilized inside this container 18 when the chemical conglomerate is placed inside this container. To accomplish a complete waterproof bond between the inside wall of the container and the sides of the chemical conglomerate, the inside walls and bottom of the container would first be coated with the viscous waterproof coating 10 in sufficient quantity that it would completely fill in the space between the inside surfaces of the container and the sides and bottom of the chemical conglomerate when the chemical conglomerate was placed inside the container. There can be plastic formed bulkheads 15 placed at intervals inside the can or container 18 forming chambers 16 in container 18. These bulkheads 15 create the narrow opening between the larger chambers 16 at regular or irregular intervals as desired. This restriction 15 is useful in diminishing the amount of water that can wash in upon the chemical located in the larger diameter segments 16 which are located on either side of the flow restricting bulkhead 15.

It is obvious that the shapes described and the coatings mentioned above may be replaced by other means and yet not avoid the scope of this patent. For example, the waterproof coating 10 in FIG. 1 need not be a coating at all but for example it could be made out of a circular sleeve of plastic into which the chemical conglomerate cylinder or other shape could be inserted. This plastic cylinder container could be rigid or flexible and sealed on its end or ends after filling by any common method now in use to accomplish such a sealing. Such sealing methods are in common use and include gluing shut the ends or just the one end with a glue or solvent or using a heat sealing or heat shrinking method and so on.

It is also obvious that contrary to the FIG. 1 arrangement of the two coatings, that either one of those coatings could be used by itself without the other coating or even three coatings or more could also be employed without going outside the teachings and coverage of this patent.

It is obvious that the embodiments of this invention could be successfully effected using many different types of materials other than those described in this patent and even different from those normally used currently. I do not intend to limit these designs to only chemicals or plastics or some other polymers. Even steel or some other metal cans could be used to contain the chemicals with no coatings over the surface of the chemicals of any kind. The chemicals could be packed into the cans with only one end of the can being open and used by submersing it in water in just that fashion with no coatings of any kind involved. The metal can could be sealed at its open end with a lid that could exhibit its own sealed opening. The container could also be a glass container without going outside the scope of this patent.

I claim:

1. A chemical conglomerate comprising sodium lauryl sulfate and a water soluble binder for retarding the dissolution of the conglomerate in water, said chemical conglomerate being at least partially coated with a sealant for restricting dispersion of said chemical conglomerate into water.

2. The chemical conglomerate as in claim 1, wherein said sealant comprises a caulking material.

3. The chemical conglomerate as in claim 1, wherein said water soluble binder comprises white glue.

4. The chemical conglomerate as in claim 1, further comprising an outer coating of a water soluble composition.

5. The chemical conglomerate as in claim 4, wherein said water soluble composition comprises white glue.

6. The chemical conglomerate as in claim 1, further comprising a drying agent for the production of particulates and other shapes.

7. The chemical conglomerate as in claim 6, wherein said drying agent comprises granular anhydrous sodium sulfate.

8. The chemical conglomerate as in claim 6, wherein said drying agent is no more than one third and said sodium lauryl sulfate is no less than two thirds the volume of said chemical conglomerate.

9. The chemical conglomerate as in claim 1, further comprising an imbedded wire that protrudes from the surface of said chemical conglomerate.

10. The chemical conglomerate as in claim 1, wherein said conglomerate is configured as a longitudinal member having an outer dimension and further comprising restrictive locations along said longitudinal member, having smaller dimensions than said outer dimension.

11. The chemical conglomerate as in claim 10, formed with bulkheads interspersed along its length which bulkheads have at least one hole included in them.

12. An assembly containing a chemical conglomerate comprising sodium lauryl sulfate and a water soluble binder for retarding the dissolution of the conglomerate in water, said chemical conglomerate being at least partially coated with a sealant for restricting dispersion of said chemical conglomerate into water and a container for encasing said chemical conglomerate.

13. The assembly in claim 12, wherein said sealant comprises a caulking material.

14. The assembly as in claim 12, wherein said water soluble binder comprises white glue.

15. The assembly as in claim 12, further comprising an outer coating of a water soluble composition.

16. The assembly as in claim 15, wherein said water soluble composition comprises white glue.

17. The assembly as in claim 12, further comprising a drying agent for the production of particulates and other shapes.

18. The assembly as in claim 17, wherein said drying agent comprises granular anhydrous sodium sulfate.

19. The assembly as in claim 12, further comprising an imbedded wire that protrudes from the surface of said chemical conglomerate.

20. The assembly as in claim 12, wherein said conglomerate is configured as a longitudinal member having an outer dimension and further comprising restrictive locations along said longitudinal member, having smaller dimensions than said outer dimension.

21. The assembly as in claim 20, wherein said restrictive locations are formed with bulkheads interspersed along said conglomerate length which bulkheads have at least one hole included in them.

22. The assembly as in claim 12, said container further comprising a lid to seal shut the open end of said container.

23. The assembly as in claim 22, wherein said container lid comprises a pop top said pop top creating when activated a small opening in said lid.

24. The assembly as in claim 22, wherein said container lid comprises at least one aperture that pierces the surface of said lid to the opposite side thereof with or without a closure.
